(19) United States
(12) Patent Application Publication
(10) Pub. No.: US 2019/0275682 A1
(43) Pub. Date: Sep. 12, 2019

(54) METHOD AND APPARATUS FOR HANDLING A WHEEL

(71) Applicant: EISENMANN SE, Boblingen (DE)

(72) Inventor: Marc Walter Kirchner, Bammental (DE)

(21) Appl. No.: 16/292,594

(22) Filed: Mar. 5, 2019

(30) Foreign Application Priority Data
Mar. 7, 2018 (DE) 10 2018 105 196.4

(51) Int. Cl. B25J 15/00; B65G 47/90

(52) U.S. Cl. CPC B25J 15/0014; B65G 47/905; B25J 15/0033

(57) ABSTRACT

A method for handling a wheel which is carried by a spindle in which a robot arm grips the spindle at a robot gripping position and removes same from a transport vehicle. Since the wheel is not directly gripped by the robot arm, damage to the wheel that could be caused by clamping of the robot arm on the wheel is avoided. Preferably, before or during the removal of the spindle from the transport vehicle, a locking element on the transport vehicle releases the spindle.

### RELATED APPLICATIONS

The present application claims priority to German Patent Application No. 10 2018 105 196.4 filed Mar. 7, 2018, the contents of which are fully incorporated herein by reference.

### BACKGROUND OF THE INVENTION

### 1. Field of the Invention

The invention relates to a method for handling a wheel, and to an apparatus with a spindle, a transport vehicle and a robot arm for carrying out the method.

### 2. Description of the Prior Art

During lacquering of wheels, the wheels pass through a plurality of processing stations. The wheels are frequently transported here on spindles so that the wheels can be held by a minimal supporting surface and can easily be removed with the aid of a clamping apparatus. For transporting the spindles, use is frequently made of a conveyor of the type as is known, for example, from DE 10 2008 006 171 B3. The spindles are connected here to a horizontally running endless link chain which conveys the spindles in a conveying direction.

In order to supply a wheel to a processing station, the wheel is gripped by means of a clamping apparatus carried by a handling device, is lifted off the spindle and deposited at the desired location in the first processing station. The spindles are mounted fixedly here on the transport vehicles. In some processing steps, the wheels do not have to be lifted off, but rather can remain on the spindles during the processing.

After the processing is at an end, the clamping apparatus picks up the processed wheel and deposits the latter on the same spindle or on another free spindle. The wheel is subsequently transported on the spindle by means of the transport vehicle to the next processing station.

However, because of the forces which are exerted on the wheel by the clamping of the wheel by means of the clamping apparatus, scratches, gripping marks or deformations may arise on the wheel.

Furthermore, wheels of different shape and size are frequently processed in a lacquering plant. Since the spindles are fixedly connected to the respective transport vehicle, the same type of spindle has to be used for all of the wheels. The conveying technology therefore has to have height compensation for each wheel in order to make it possible to handle wheels of differing sizes.

### SUMMARY OF THE INVENTION

It is therefore an object of the invention to provide a method for handling a wheel, in which the risk of damage to or lacquer defects on the wheel is reduced and the wheels can be transported more flexibly and more efficiently. It is furthermore the object of the invention to specify an apparatus suitable for carrying out the method.

This object may be achieved by a method for handling a wheel carried by a spindle, in which a robot arm grips the spindle at a robot gripping position and removes same from a transport vehicle. The method has the advantage that, in contrast to the cited prior art, the wheel is not directly gripped by the robot arm. As a result, damage to the wheel that may be caused by the clamping of the robot arm on the wheel is avoided.

Furthermore, use may be made of spindles which are each individually adapted to a type of wheel, in particular to the width of the wheel. By means of the adaptation of the geometry, in particular the height, of the spindles to the dimensions of the respective wheel, the same height for each wheel can be set within a transport section. This avoids a variation in deposition that generally has to be compensated for by the handling system of the lacquering plant.

In one embodiment, before or during the removal of the spindle from the transport vehicle, a locking element on the transport vehicle releases the spindle. The locking element secures the spindles on the transport vehicle and prevents movements of the spindle (with the exception of rotations about the spindle longitudinal axis) relative to the transport vehicle. By release of the spindle by the locking element, the spindle with the wheel held by it can be removed from the transport vehicle rapidly and with little wear in order to be subsequently deposited either in a processing station or on another transport vehicle where the spindle is locked again. Locking is understood here as meaning a form-fitting and/or force-fixing of the spindle by means of a movable locking element.

As an alternative to a locking element, a transition fit can also be provided between the spindle and the transport vehicle for fastening the spindle to the transport vehicle. As a result, the structural outlay of the fastening is lower, but a high degree of wear can be anticipated at the transition fit during frequent removal and insertion of the spindle from and into the transport vehicle. Furthermore, a magnetic fastening of the spindle to the transport vehicle is possible. The spindle can thereby be fixed particularly rapidly and with little wear.

It can be advantageous here if, during the removal of the spindle from the transport vehicle, the locking element automatically released the spindle if a tensile force exerted on the spindle by the robot arm exceeds a threshold value. The locking element is not actively unlocked here, but rather the spindle is released only by means of a pulling movement of the spindle by means of the robot arm. The robot arm exerts a tensile force, which is substantially directed along the spindle longitudinal axis, on the spindle. After a threshold value of the tensile force is exceeded, the spindle is released by the locking element. The threshold value substantially corresponds to the weight of the spindle and, if present, of the wheel and the frictional force to be overcome between the locking element and the spindle. The threshold value can be set individually, for example via the normal force which is exerted on the spindle by the locking element.

The locking element is preferably automatically released via structural features on the locking element, for example via the shape of that end of the locking element which faces the spindle and/or via the shape of the spindle.

Alternatively, during the removal of the spindle from the transport vehicle, the locking element can be released with the aid of an actuator arranged in a stationary manner. The actuator here can be designed, for example, as a stepping motor or piezo motor. An electromagnet as actuator is also conceivable. The actuator can be activated by an optical element, for example a light barrier. It is also possible for the controller of the robot to trigger the activation of the actuator.

As an alternative thereto, before the removal of the spindle from the transport vehicle, the robot arm can actuate the locking element or a mechanical actuator element connected thereto, and can thereby release the spindle. As an alternative thereto, however, the mechanical actuator element can also be actuated by means of manual actuation by a person in order to release the spindle. Furthermore, a connecting link is conceivable which is arranged in a stationary manner next to the transport section and actuates the locking element.

With regard to the apparatus, the object mentioned at the beginning is achieved by an apparatus for handling a wheel, comprising a spindle which is designed to carry the wheel, a transport vehicle and comprising a robot arm. According to the invention, the transport vehicle is designed to releasably receive the spindle. The spindle is grippable at a robot gripping position by the robot arm and removable from the transport vehicle.

In one embodiment, a locking element for locking and releasing the spindle is provided on the transport vehicle. The locking element can be designed here as a sectioned ball or sectioned cylinder. It is advantageous here to mount the locking element in the transport vehicle so as to be rotatable about an axis of the sectioned ball or of the sectioned cylinder, which axis is parallel to the section plane. However, the locking element can also be movable in a translatory manner for locking the spindle. In this case, for example, the ball as locking element would not be sectioned, but rather would be completely spherical.

The locking element is preferably suitable for automatically releasing the spindle as soon as a tensile force exerted on the spindle by the robot arm exceeds a threshold value.

Alternatively, for the locking and release of the spindle, the locking element can be controllable by means of an actuator arranged in a stationary manner.

In one embodiment, a groove is provided on a circumferential surface of the spindle, in which groove the locking element of the transport vehicle engages in the locked state of the spindle. The locking element is preferably designed here as a pin, the point of which engages in the groove of the transport vehicle.

Alternatively, an extendable pin can be provided with a rubber roller which, in the locked state, acts on the circumferential surface of the spindle and, by means of a sufficient contact pressure force, locks the spindle to the transport vehicle. The groove on the spindle can thereby be omitted. Furthermore, the wear is lower because of the lower friction between the locking element and the spindle.

In one embodiment, for the removal of the spindle from the transport vehicle, the locking element or a mechanical actuator element arranged on the outside of the transport vehicle is actuable by the robot arm and, as a result, the spindle is releasable.

The apparatus for handling a wheel with a spindle can additionally comprise a monitoring device in which, after the locking of the spindle to the transport vehicle, the secure fixing of the spindle on the transport vehicle by means of the locking is monitored. The monitoring can be carried out, for example, using the robot arm. After the spindle has been placed onto the transport vehicle and the locking element has locked the spindle, the robot arm can exert a tensile force on the spindle. The monitoring device classifies the locking as being fixed when the tensile force of the robot arm reaches a threshold value without the spindle being released from the transport vehicle. Alternatively, a light barrier or another optical element for detecting the locked state of the locking element can also be provided.

The invention furthermore relates to a spindle for transporting a wheel with a wheel receiving element and a robot gripping position, at which the spindle is grippable and movable by a robot arm. According to the invention, the spindle is designed to be releasably locked to a transport vehicle.

A locking receptacle for coupling to the transport vehicle can be formed here on the spindle in order to receive a locking element of the transport vehicle, wherein the locking receptacle is preferably an encircling groove. As an alternative thereto, the manufacturing dimensions can be selected in such a manner that a transition fit or press fit to the transport vehicle is possible.

At the robot gripping position, the spindle can have a bushing which is fastened to the spindle. The bushing can be fastened in particular concentrically with respect to the spindle. In particular, the bushing can be fastened to the spindle by means of a press fit or a tongue and groove connection. As an alternative thereto, the robot gripping position can be designed as a hardened point of the spindle.

The spindle is preferably rotatable by means of a gear wheel, which is fastened thereto, with the aid of an actuating means which is independent of the transport vehicle. Alternatively, the spindle can be driven by means of an electric motor arranged in the transport vehicle.

The invention also relates to a transport vehicle for transporting spindles which are suitable for the transport of wheels, wherein the transport vehicle has a spindle guide for receiving a spindle. According to the invention, a locking element is provided for locking and releasing the spindle on the transport vehicle.

In one embodiment, the locking element is automatically unlockable if a tensile force exerted on the spindle exceeds a threshold value.

The locking element is preferably unlockable with the aid of an actuator arranged in a stationary manner. The actuator can be designed here, for example, as a stepping motor or piezo motor. Alternatively, the actuator can be a connecting link.

The spindle guide can be particularly preferably funnel-shaped. As an alternative thereto, the spindle guide can have a simple cylinder shape. This results in a larger axial guide surface for an object to be inserted therein, but the insertion operation is more complicated.

The spindle guide of the spindle particularly preferably has a wearing bushing. A wearing bushing is generally configured to avoid wear to the spindle. This is achieved especially by the material of the wearing bushing having a lower hardness than the spindle to be carried. The intention as a result is for less wear in the form of material abrasion to arise at the spindle. The wearing bushing can therefore be designed especially as an interchangeable component.

As an alternative thereto, the spindle guide can be designed without a wearing bushing, but with greater play for the object to be inserted, and therefore less friction.

The transport vehicle is preferably arranged in a guide of a conveyor. A driven conveyor chain to which the transport vehicles are connected is arranged in the guide. The transport vehicle here can be connected in particular releasably to the chain, for example by means of a driver which is provided on the transport vehicle and is gripped in a form-fitting manner by a revolving conveyor chain or by an element fastened to the conveyor chain, in order to convey the transport vehicle along the guide. However, when required, the revolving conveyor chain can pass the transport vehicle without the conveyor chain gripping the transport vehicle. As a result, it is possible to convey certain conveyor vehicles by means of the conveyor chain while other conveyor vehicles are at a standstill. This conveying principle is generally known as inverted power and free conveyors.

The transport vehicle here can have rollers as running means and/or guide means in order to obtain smooth running or smooth-running guidance of the transport vehicle. Instead of the rollers, sliding surfaces, for example runners, can also be provided.

Other advantages and aspects of the present invention will become apparent upon reading the following description of the drawings and detailed description of the invention.

### BRIEF DESCRIPTION OF THE DRAWINGS

Exemplary embodiments of the invention will be explained in more detail below with reference to the drawings, in which:

FIG. 1 shows an apparatus according to the invention for handling a wheel in a side view according to a first exemplary embodiment;

FIG. 2 shows part of the apparatus shown in FIG. 1, wherein the spindle is locked in the transport vehicle;

FIG. 3 shows that part of the apparatus which is shown in FIG. 2, wherein the spindle is unlocked, and a robot arm which grips the spindle;

FIG. 4 shows part of an apparatus according to the invention according to a second embodiment, wherein the spindle is locked in the transport vehicle;

FIG. 5 shows that part of the apparatus which is shown in FIG. 4, wherein the spindle is unlocked.

### DETAILED DESCRIPTION OF THE INVENTION

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

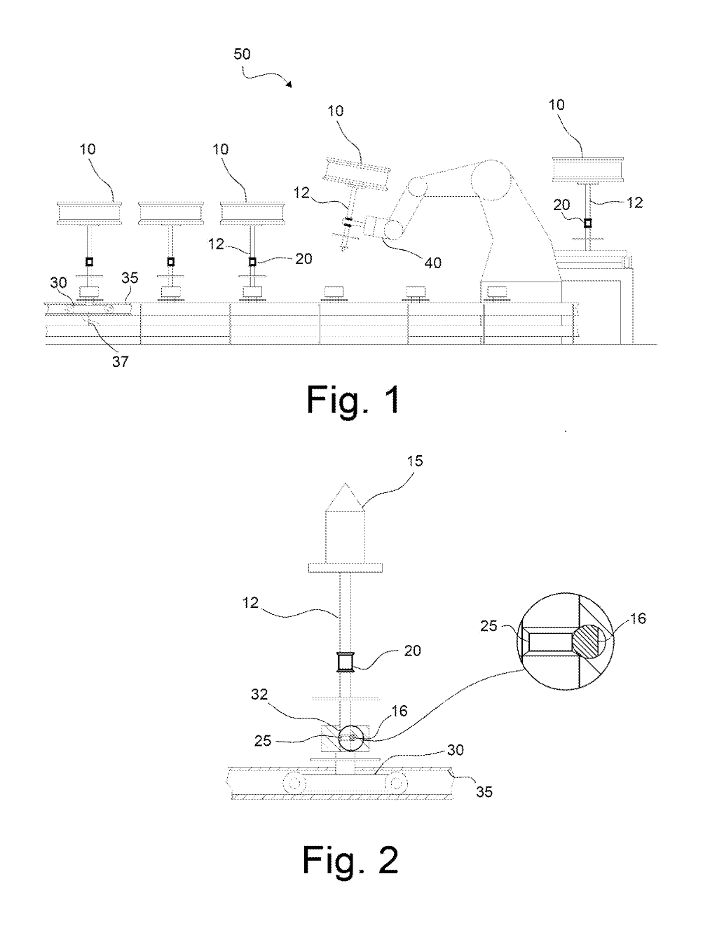

FIG. 1 shows an apparatus 50 for handling a wheel 10. In a lacquering plant, a plurality of wheels 10 are carried on spindles 12. Each spindle 12 is connected to a transport vehicle 30 arranged in a guide 35. Each transport vehicle 30 has a driver 37 which is grasped by a revolving conveyor chain (not depicted). However, the driver 37 can change its position in such a manner that the driver 37 is not grasped by the conveyor chain and therefore the transport vehicle 30 is not conveyed by the conveyor chain.

It can also be advantageous to provide a plurality of spindles 12 which are connected to a single transport vehicle 30. The spindles 12 are moved through the lacquering plant by means of the transport vehicles 30 and each have a robot gripping position 20 at which the spindle can be gripped by means of a robot arm 40 in order to supply said spindle to a processing station or to transfer same to a different transport section.

FIG. 2 shows the spindle 12 which is shown in FIG. 1 and is locked to the respective transport vehicle 30 by means of a locking element 16. As an alternative, a transition fit or press fit can be provided between the transport vehicle 30 and the spindle 12.

The locking element 16 is designed as a sectioned ball which is mounted in the transport vehicle 30 so as to be rotatable about an axis parallel to the section plane. Alternatively, the locking element 16 can also be designed as a sectioned cylinder. In the locked state, a non-sectioned region of the ball engages in an encircling groove 25 formed in the spindle, in order to fix the spindle 12 to the transport vehicle 30. The spindle 12 is as a rule rotatable by means of a gear wheel. An encircling groove 25 is therefore particularly advantageous since the locking element 16 remains in engagement during the rotation in the groove 25.

In the case of embodiments of the spindle 12 without a groove 25, the locking element 16 can have a roller which is pressed against the surface of the spindle 12. During the rotation of the spindle 12, the roller of the locking element 16 rotates, and therefore a force is exerted against the surface of the spindle 12 during the rotation of the spindle 12.

The spindle 12 has a spindle guide 32 which is configured for receiving the spindle 12 in the transport vehicle 30. The spindle guide 32 can have in particular a wearing bushing which minimizes the wear on the spindle guide 32 of the transport vehicle 30 due to repeated insertion and removal of the spindle 12. In general, an inner surface of the wearing bushing is composed of a softer material than the spindle 12. By means of the pairing of the different material hardnesses, the wear substantially arises at the wearing bushing, and therefore the spindle 12 is subject to less wear. The cost-effective wearing bushing merely therefore has to be interchanged as soon as increased wear phenomena occur on the wearing bushing.

The spindle 12 furthermore has a receiving spike 15 for receiving a wheel 10 and a robot gripping position 20 at which the spindle 12 is grippable by a robot arm 40. The robot gripping position 20 preferably comprises a bushing which is arranged substantially concentrically with respect to the spindle 12. The bushing is preferably composed of a hardened material in order to minimize wear of the robot gripping position 20. The shape of the bushing substantially depends on the shape of the gripper of the robot arm 40. The bushing preferably has a substantially circular-cylindrical outer surface, but a polygonal outer surface can also be advantageous for better grippability of the spindle 12. The bushing can be fastened to the spindle 12 by means of a press fit or transition fit. Also suitable is an integrally bonded connection, for example by means of spot welding, or a tongue and groove connection.

As an alternative thereto, the robot gripping position 20 can be designed as a hardened point of the spindle and/or can have a grippy structure for slip-free and low-wear gripping of the spindle.

The robot arm grips the spindle 12 at the robot gripping position 20 in order to remove the same from the transport vehicle 30. The robot arm 40 can preferably remove the spindle 12 only after the spindle 12 has been released by the locking element 16, for example by means of an actuator connected to the locking element 16.

The locking element 16 can also automatically release the spindle 12 by the robot arm 40 exerting a tensile force, which exceeds a threshold value, on the spindle 12. Said threshold value can be set by the fact that a spring is provided on the locking element 16, said spring exerting a force on the spindle 12 that can be set by means of the spring rigidity. The resulting friction force which is directed counter to the tensile force of the robot arm 40 is decisive for the threshold value to be achieved. The friction force can also arise here by means of the described transition fit or press fit.

The robot arm 40 subsequently deposits the wheel 10 at a processing station or on a preferably identically designed transport vehicle 30 of the next transport section. The locking of the spindles 12 to the transport vehicles 30 of the next transport section can take place automatically here, similarly to the unlocking during the removal, for example by means of a spring which is compressed when the spindle 12 is introduced into the spindle guide 32 of the transport vehicle 30.

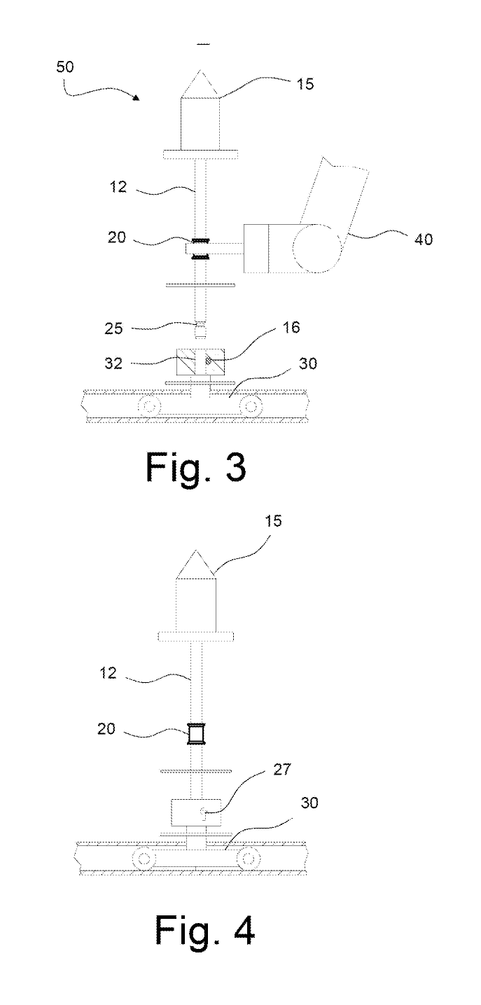

FIG. 3 shows that part of the apparatus 50 which is shown in FIG. 2 in the unlocked state of the spindle 12. The locking element 16, which is designed as a sectioned ball, is rotated by 180° in relation to FIG. 2. The sectioned region of the locking element 16 therefore faces the spindle 12, and therefore the locking element 16 no longer engages in the groove, shown in FIG. 3, of the spindle 12. The spindle 12 can now be gripped by the robot arm 40 at the robot gripping position 20 and transported to the desired location.

FIG. 4 shows a mechanical actuator element 27 which is connected to the locking element 16. In the position shown of the mechanical actuator element 27, the locking element 16 is locked. The mechanical actuator element 27 is actuatable by human force or by the robot arm 40. Alternatively, the mechanical actuator element 27 can be replaced by an actuator.

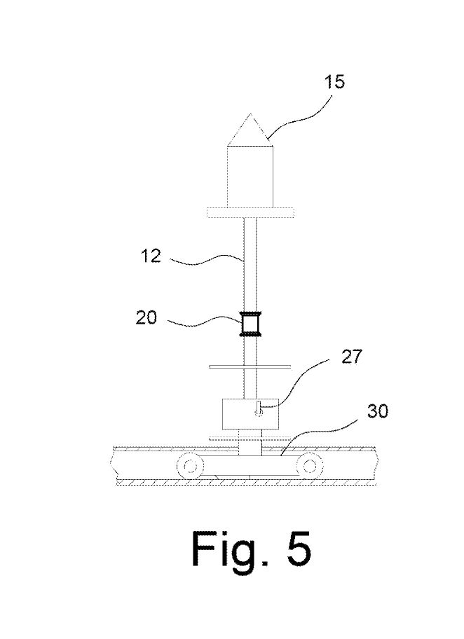

FIG. 5 shows the mechanical actuator element 27 from FIG. 4, wherein the mechanical actuator element 27 is in a position corresponding to the unlocked state of the locking element 16.

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

What is claimed is:

1. A method for handling a wheel which is carried by a spindle, comprising:
gripping a spindle carrying a wheel using a robot arm at a robot gripping position and removing the same from a transport vehicle.

2. The method as claimed in claim 1, wherein, before or during the removal of the spindle from the transport vehicle, a locking element on the transport vehicle releases the spindle.

3. The method as claimed in claim 2, wherein, during the removal of the spindle from the transport vehicle, the locking element automatically releases the spindle when a tensile force exerted on the spindle by the robot arm exceeds a threshold value.

4. The method as claimed in claim 2, wherein, during the removal of the spindle from the transport vehicle, the locking element releases the spindle with the aid of an actuator arranged in a stationary manner.

5. The method as claimed in claim 2, wherein, before the removal of the spindle from the transport vehicle, the robot arm actuates the locking element or a mechanical actuator element connected thereto, and thereby releases the spindle.

6. An apparatus for handling a wheel, comprising:
a spindle which is designed to carry a wheel;
a transport vehicle; and
a robot arm;
wherein
the transport vehicle is designed to releasably receive the spindle, and wherein the spindle is grippable by the robot arm at a robot gripping position and is removable from the transport vehicle.

7. The apparatus as claimed in claim 6, wherein a locking element for locking and releasing the spindle is provided on the transport vehicle.

8. The apparatus as claimed in claim 7, wherein the locking element is suitable for automatically releasing the spindle as soon as a tensile force exerted on the spindle by the robot arm exceeds a threshold value.

9. The apparatus as claimed in claim 7, wherein, for the locking and release of the spindle, the locking element is controllable by means of an actuator arranged in a stationary manner.

10. The apparatus as claimed in claim 7, wherein a groove is provided on a circumferential surface of the spindle, in which groove the locking element of the transport vehicle engages in the locked state of the spindle.

11. The apparatus as claimed in claim 7, wherein, for the removal of the spindle from the transport vehicle, the locking element or a mechanical actuator element arranged on the outside of the transport vehicle is actuable by the robot arm and, as a result, the spindle is releasable.

12. A transport vehicle for transporting spindles which are suitable for transporting wheels, comprising:
a spindle guide for receiving a spindle,
wherein
a locking element is provided for locking and releasing the spindle on the transport vehicle.

13. The transport vehicle as claimed in claim 12, wherein the locking element is automatically unlockable if a tensile force exerted on the spindle exceeds a threshold value.

14. The transport vehicle as claimed in claim 12, wherein the locking element is unlockable with the aid of an actuator arranged in a stationary manner.

15. The transport vehicle as claimed in claim 12, wherein the locking element is designed as a cylinder sectioned parallel to the longitudinal axis of said locking element or as a sectioned ball and is mounted rotatably.

16. The transport vehicle as claimed in claim 12, wherein the spindle guide is funnel-shaped.

17. The transport vehicle as claimed in claim 12, wherein the spindle guide of the spindle has a wearing bushing.
